(19) United States
(12) Patent Application Publication
(10) Pub. No.: US 2024/0384019 A1
(43) Pub. Date: Nov. 21, 2024

(54) ETHYLENE-A-OLEFIN-NON-CONJUGATED DIENE COPOLYMERS AND BLENDS THEREOF WITH A HIGH DIENE CONTENT PER POLYMER CHAIN

(71) Applicant: ARLANXEO NETHERLANDS B.V., RD Geleen (NL)

(72) Inventors: Philip James HOUGH, AG Grevenbicht (NL); John BEELEN, PX Heerlen (NL); Raffaele BERNARDO, CK Maastricht (NL)

(73) Assignee: ARLANXEO NETHERLANDS B.V., RD Geleen (NL)

(21) Appl. No.: 18/693,842

(22) PCT Filed: Sep. 20, 2022
(86) PCT No.: PCT/EP2022/075998

§ 371 Date: Mar. 20, 2024

(30) Foreign Application Priority Data
Sep. 22, 2021 (EP) 21198284.8

(51) Int. Cl. C08F 210/18; C08F 2/06; C08J 3/20; C08J 3/24; C08K 3/04; C08K 3/06; C08L 23/16

(52) U.S. Cl. CPC C08F 210/18; C08F 2/06; C08J 3/203; C08J 3/24; C08K 3/04; C08K 3/06; C08L 23/16; C08J 2323/16; C08L 2205/025

(57) ABSTRACT

A polymer composition comprising at least one EPDM polymer, wherein the at least one EPDM has an ENB content per polymer chain (EPC) of from 80 to 150 determined according to equation (I):

$$EPC = ( [ ENB ] \times 10 \times Polymer Mn ) / 120 g / mol \qquad ( I )$$

wherein ‘[ENB]’ is the content of units derived from ENB in the EPDM polymer in % by weight (based on the total weight of the polymer which is 100% by weight) and Polymer Mn is the number average molecular weight in kg/mol of the EPDM polymer as determined by gel permeation chromatography a content of ENB from 6 to 20% by weight. Also provided is a polymer blend composition comprising a blend of a first EPDM polymer and a second EPDM polymer wherein the polymer blend has an ENB content per polymer chain (EPC) of from 80 to 150 and wherein the polymer blend has a total ENB content of from 7.5 to 20% by weight based on the total weight of the polymer blend. Also provided are curable compounds containing the polymer or the blend, methods of making the compounds, cured compounds and articles.

### FIELD

The present disclosure relates to ethylene-a-olefin-non-conjugated diene copolymer compositions, vulcanizable rubber compositions containing the same and vulcanized articles obtained from them.

### BACKGROUND

Ethylene-a-olefin elastomers, particularly ethylene-propylene-diene polymers (EPDM) are recognized as excellent general-purpose elastomers that are useful in a wide variety of applications.

EPDM polymers essentially consist of units derived from ethylene and propylene with smaller amounts of units derived from one or more than one non-conjugated diene to introduce unsaturation into the polymer chain for facilitating polymer crosslinking. EPDM rubbers exhibit superior resistance to oxidation, ozone and heat aging compared to conjugated diene rubbers and have been widely used in numerous applications.

A disadvantage of EPDM polymers is their inferior performance in dynamic applications, i.e., applications where shaped parts are subjected to repeated stress forces and dynamic loading. Typical dynamic applications include engine mounts, flexible couplings and torsional vibration dampers, belts, muffler hangers, air springs and bridge bearings.

For dynamic applications EPDM polymers are required that can be processed into compounds having good mechanical and elastic properties. Generally accepted mechanical properties an EPDM composition that is suitable for dynamic applications include a shore A hardness of at least 40, a tensile strength of at least 19 MPa and an elongation at break of at least 650 at a low loading with fillers, for example at a loading with 40 to 50 phr carbon-based filler.

The mechanical properties of EPDM polymers improve with increasing ethylene content because of increased crystallinity of the polymer, and with increasing molecular weight. However, high molecular weight EPDM polymers with a high ethylene content also have viscosities which makes it challenging to produce them on a large scale or to process them during work up or when making rubber compounds.

One way to mitigate these difficulties is to produce high molecular weight polymers with a high ethylene content by a slurry process. In a slurry process the polymerization is carried out without solvent but instead an excess of monomer is used as polymerization medium. Polymers produced by a slurry process are difficult to wash and typically contain higher amounts of residues from the catalysts than polymers produced by solution polymerization. Since the catalysts typically contain heavy metals, catalyst residues are generally undesired and are to be kept to a minimum.

Another known route for improving processability of high molecular weight polymers with a high ethylene content is to add oil during their production and to create so called “oil extended polymer”. Commercially available EPDM rubbers with very high molecular weight are typically available as oil-extended polymer with 100 phr of extender oil, such as for example KELTAN K4869C available from ARLANXEO Netherlands B.V. High amounts of extender oil, however, are detrimental for dynamic performance.

The vibration isolation is a key performance criterium for dynamic applications of EPDM rubber compositions. This property can be determined by the loss angle, or tan delta, at a defined strain and for a given range of frequencies. A tan delta value of zero refers to an “ideal” elastic material. Such a material would exhibit high resilience values, ideally 100%. Therefore, the lower the tan delta of a rubber compound the higher its elasticity. Another parameter is the dynamic stiffness (or “spring constant”) of a rubber mount. In practical terms it is often related to the hardness or modulus at low elongation (i.e., the tangent at zero strain in the stress/strain curve) of the rubber. Comparisons are made with rubber materials of about the same shore A hardness and desirably, the dynamic stiffness should be low.

The elastic and dynamic properties of EPDM polymers are predominantly governed by the polymer architecture and the polymer network created upon curing.

In international patent application WO2014/206952A1 EPDM compositions suitable for dynamic applications are reported that have a polymer architecture defined by a narrow molecular weight distribution of less than 3 and a phase angle delta min of less than 2.5. The phase angle delta min is controlled by molecular weight and branching of the polymer. Molecular weight distributions of greater than 3 are associated in this reference with poorer elastic properties. The polymer compositions have an amount of extender oil of from 30 to 70 phr. However, there is a need for alternative polymer compositions that are suitable for dynamic applications and provide compounds with good dynamic elastic properties.

### SUMMARY

It has now been found that an EPDM polymer architecture defined by a specific diene content per polymer chain at a minimum content of ENB can be used to make EPDM polymer compositions that are particularly suitable for use in dynamic applications. The architecture may be created by using a single polymer or by a combination of at least two polymers. Surprisingly, such polymer architecture allows to provide polymers with increased molecular weight distributions and thus potentially easier processing behavior, while not significantly reducing their dynamic elastic properties.

Therefore, in the following there is provided a polymer composition comprising at least one EPDM polymer, wherein the at least one EPDM polymer comprises
(i) from 59% to 70% by weight of units derived from ethylene and
(ii) from 7.5 to 20% by weight of units derived from one or more non-conjugated dienes, preferably selected from 5-methylene-2-norbornene (MNB), 5-ethylidene-2-norbornene (ENB), 5-vinyl-2-norbornene (VNB), dicyclopentadiene (DCPD) or a combination thereof and wherein the EPDM polymer comprises at least 6.0% preferably at least 7% by weight of units derived from the non-conjugated diene 5-ethylidene-2-norbornene (ENB),
(iii) at least 17% by weight of units derived from propylene,
(iv) from 0 to 70 parts per hundred parts of first polymer of extender oil,
(v) optionally, from 0 to 20% by weight of units derived from one or more other comonomers
   wherein the % by weight is based on the total weight of the polymer which is 100%, and wherein the EPDM polymer has an ENB content per polymer chain (EPC) of from 80 to 150 determined according to equation (I):

$$EPC = ( [ ENB ] \times 10 \times Polymer Mn ) / 120 g / mol \qquad ( I )$$

wherein ‘[ENB]’ is the content of units derived from ENB in the EPDM polymer in % by weight (based on the total weight of the polymer which is 100% by weight) and Polymer Mn is the number average molecular weight of the EPDM polymer in kg/mol as determined by gel permeation chromatography.

In another aspect there is provided a polymer blend composition comprising a blend of a first EPDM polymer and a second EPDM polymer wherein the polymer blend has an ENB content per polymer chain of from 80 to 150 and wherein
the first EPDM polymer has from 59% to 65% by weight of units derived from ethylene and at least 17% by weight of units derived from propylene and further comprises units derived from at least one non-conjugated diene, preferably selected from 5-methylene-2-norbornene (MNB), 5-ethylidene-2-norbornene (ENB), 5-vinyl-2-norbornene (VNB), dicyclopentadiene (DCPD) or a combination thereof, wherein the % by weight is based on the total weight of the first EPDM polymer,
wherein the second EPDM polymer has from 35 to 65% by weight of units derived from ethylene, preferably from 35 to 58% by weight, from at least 17% by weight of units derived from propylene and further comprises units derived from and at least one non-conjugated diene, preferably selected from 5-methylene-2-norbornene (MNB), 5-ethylidene-2-norbornene (ENB), 5-vinyl-2-norbornene (VNB), dicyclopentadiene (DCPD) or a combination thereof and wherein the % by weight is based on the total weight of the second EPDM polymer,
from 0 to 70 parts per hundred parts of first and second EPDM polymer of extender oil,
optionally, wherein either the first or the second EPDM polymer or both comprise from 0 to 20% by weight based on the total weight of the polymer of units derived from one or more other comonomers,
and wherein the polymer blend has a total ENB content of from 7.5 to 20% by weight based on the total weight of the polymer blend.

In another aspect there is provided a rubber compound comprising either the polymer composition according or the polymer blend composition and further comprising at least one filler and at least one curing agent, wherein, optionally, the rubber compound is a vulcanized rubber compound and comprises the reaction product of subjecting the rubber compound to a curing reaction.

In yet another aspect there is provided a method of making the rubber compound comprising combining either the polymer composition or the polymer blend with at least one filler and at least one curing agent, and, optionally, subjecting the compound to a curing reaction.

In a further aspect there is provided an article comprising the rubber compound, preferably in its cured form wherein the article, preferably is selected from an engine mount, a flexible coupling, a torsional vibration damper, a muffler hanger, air springs and bridge bearings.

### DETAILED DESCRIPTION

In the following description norms may be used. If not indicated otherwise, the norms are used in the version that was in force on Mar. 1, 2020. If no version was in force at that date because, for example, the norm has expired, then the version is referred to that was in force at a date that is closest to Mar. 1, 2020.

In the following description the amounts of ingredients of a composition or polymer may be indicated interchangeably by “weight percent”, “wt. %” or “% by weight”. The terms “weight percent”, “wt. %” or “% by weight” are used interchangeably and are based on the total weight of the composition or polymer, respectively, which is 100% unless indicated otherwise. When amounts of units derived from a monomer or other ingredients of the polymer are expressed in % by weight based on the weight of copolymer and the copolymer is oil-extended the total weight of the copolymer still refers to the total weight of the copolymer. In other words, the total weight of copolymer of an oil-extended copolymer is the weight of the copolymer and the extender oil minus the weight of the extender oil.

The term “phr” means parts per hundred parts of rubber, i.e. the weight percentage based on the total amount of rubber which is set to 100% by weight. The ethylene-copolymer according to the present disclosure is a rubber. If a composition contains one or more ethylene-copolymer or one ethylene-copolymer and one or more other rubbers, the “phr” refer to the total amount of these rubbers.

Ranges identified in this disclosure include and disclose all values between the endpoints of the range, and also include the end points unless stated otherwise.

The words “comprising” and “containing” are used interchangeably. They are meant to include the ingredients or components to which they refer but do not exclude the presence of other ingredients or components. The word “consisting” is used in a limiting sense to is meant to limit a composition to only those ingredients to which the word consisting refers.

### Polymer Compositions

In one aspect of the present disclosure there are provided polymer compositions. The polymer compositions according to the present disclosure are compositions comprising at least one EPDM polymer according to the present disclosure or that consist only of one or more EPDM polymers of the present disclosure.

### EPDM Polymers

EPDM polymer according to the present disclosure is a copolymer comprising, preferably consisting of, units derived from ethylene, one or more a-olefins-and one or more conjugated dienes. The EPDM polymers provided herein have a high ethylene content and can be used to provide compounds suitable for dynamic applications.

Preferably, the EPDM polymer comprises from 59% by weight to 70% by weight of units derived from ethylene. More preferably, the EPDM polymer according to the present disclosure comprises from 60% by weight to 68% by weight or from 61% by weight to 67% by weight of units derived from ethylene. The “% by weight” are based on the total weight of the polymer.

In addition to units derived from ethylene, the EPDM polymer according to the present disclosure comprises units derived from (i) one or more C₃-C₂₀-α-olefin, preferably propylene, and (ii) units derived from at least one non-conjugated diene, preferably comprising ENB.

### C₃-C₂₀-α-olefins

C₃-C₂₀-α-olefins (also referred to herein as” C₃-C₂₀ alpha olefins”) are olefins containing three to twenty carbon atoms and having a single aliphatic carbon-carbon double bond. The double bond is located at the terminal front end (alpha-position) of the olefin. The α-olefins can be aromatic or aliphatic, linear, branched or cyclic. Examples include propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-hepta-decene, 1-octadecene, 1-nonadecene, 1-eicosene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 9-methyl-1-decene, 11-methyl-1-dodecene and 12-ethyl-1-tetradecene. The alpha olefins may be used in combination. Preferred alpha-olefins are aliphatic C₃-C₁₂ α-olefins, more preferably aliphatic, linear C₃-C₄ α-olefins, most preferably propylene (a C₃ α-olefin) and 1-butene (C₄ α-olefin). Preferably, the ethylene-α-olefin-copolymer of the present disclosure comprises propylene. Preferably, the ethylene-copolymer comprises at least 17% by weight of units derived from propylene.

### Non-Conjugated Dienes (Mono-Polymerizable Dienes and Dual Polymerizable Dienes)

The EPDM polymer according to the present disclosure typically comprises from 7.5% by weight to 20% by weight of units derived from non-conjugated dienes. Non-conjugated dienes are polyenes comprising at least two double bonds, the double bonds being non-conjugated in chains, rings, ring systems or combinations thereof. The polyenes may have endocyclic and/or exocyclic double bonds and may have no, the same or different types of substituents. The double bonds are at least separated by two carbon atoms. The non-conjugated dienes are preferably aliphatic, more preferably alicyclic and aliphatic. Preferred non-conjugated dienes include alicyclic polyenes. Alicyclic dienes have at least one cyclic unit. In a preferred embodiment the non-conjugated dienes are selected from polyenes having at least one endocyclic double bond and optionally at least one exocyclic double bond. Non-conjugated dienes include “mono-polymerizable dienes” and “dual polymerizable dienes”.

### Mono-Polymerizable Dienes

Mono-polymerizable dienes create cure sites in the polymer chain because to a significant extent only one of the non-conjugated double bonds is converted by a polymerization catalyst. The other remains available for curing reactions.

Suitable mono-polymerizable dienes include aromatic polyenes, aliphatic polyenes and alicyclic polyenes, preferably polyenes with 6 to 30 carbon atoms (C₆-C₃₀-polyenes, more preferably C₆-C₃₀-dienes). Specific examples of non-conjugated dienes include 1,4-hexadiene, 3-methyl-1,4-hexadiene, 4-methyl-1,4-hexadiene, 5-methyl-1,4-hexadiene, 4-ethyl-1,4-hexadiene, 3,3-dimethyl-1,4-hexadiene, 5-methyl-1,4-heptadiene, 5-ethyl-1,4-heptadiene, 5-methyl-1,5-heptadiene, 6-methyl-1,5-heptadiene, 5-ethyl-1,5-heptadiene, 1,6-octadiene, 4-methyl-1,4-octadiene, 5-methyl-1,4-octadiene, 4-ethyl-1,4-octadiene, 5-ethyl-1,4-octadiene, 5-methyl-1,5-octadiene, 6-methyl-1,5-octadiene, 5-ethyl-1,5-octadiene, 6-ethyl-1,5-octadiene, 1,6-octadiene, 6-methyl-1,6-octadiene, 7-methyl-1,6-octadiene, 6-ethyl-1,6-octadiene, 6-propyl-1,6-octadiene, 6-butyl-1,6-octadiene, 4-methyl-1,4-nonadiene, 5-methyl-1,4-nonadiene, 4-ethyl-1,4-nonadiene, 5-ethyl-1,4-nonadiene, 5-methyl-1,5-nonadiene, 6-methyl-1,5-nonadiene, 5-ethyl-1,5-nonadiene, 6-ethyl-1,5-nonadiene, 6-methyl-1,6-nonadiene, 7-methyl-1,6-nonadiene, 6-ethyl-1,6-nonadiene, 7-ethyl-1,6-nonadiene, 7-methyl-1,7-nonadiene, 8-methyl-1,7-nonadiene, 7-ethyl-1,7-nonadiene, 5-methyl-1,4-decadiene, 5-ethyl-1,4-decadiene, 5-methyl-1,5-decadiene, 6-methyl-1,5-decadiene, 5-ethyl-1,5-decadiene, 6-ethyl-1,5-decadiene, 6-methyl-1,6-decadiene, 6-ethyl-1,6-decadiene, 7-methyl-1,6-decadiene, 7-ethyl-1,6-decadiene, 7-methyl-1,7-decadiene, 8-methyl-1,7-decadiene, 7-ethyl-1,7-decadiene, 8-ethyl-1,7-decadiene, 8-methyl-1,8-decadiene, 9-methyl-1,8-decadiene, 8-ethyl-1,8-decadiene, 1,5,9-decatriene, 6-methyl-1,6-undecadiene, 9-methyl-1,8-undecadiene, dicyclopentadiene, and mixtures thereof. Dicyclopentadiene can be used both as dual polymerizable or as mono-polymerizable diene.

Examples of aromatic non-conjugated polyenes include vinylbenzene (including its isomers) and vinyl-isopropenylbenzene (including its isomers).

Preferred mono-polymerizable dienes include dicyclopentadiene (DCPD), 5-methylene-2-norbornene (MNB) and 5-ethylidene-2-norbornene (ENB) with ENB being particularly preferred. The EPDM polymers according to the present disclosure comprises from 6.0% and up to 20% by weight of units derived from ENB, preferably from 7.0% by weight to 15.0% by weight.

### Dual Polymerizable Dienes

Dual polymerizable dienes are selected from vinyl substituted aliphatic monocyclic and non-conjugated dienes, vinyl substituted bicyclic and unconjugated aliphatic dienes, alpha-omega linear dienes and non-conjugated dienes where both sites of unsaturation are polymerizable by a coordination catalyst (e.g. a Ziegler-Natta Vanadium catalyst or a metallocene-type catalyst). Examples of dual polymerizable dienes include 1,4-divinylcyclohexane, 1,3-divinylcyclohexane, 1,3-divinylcyclopentane, 1,5-divinylcyclooctane, 1-allyl-4-vinylcyclo-hexane, 1,4-diallylcyclohexane, 1-allyl-5-vinylcyclooctane, 1,5-diallylcyclooctane, 1-allyl-4-isopropenyl-cyclohexane, 1-isopropenyl-4-vinylcyclohexane and 1-isopropenyl-3-vinylcyclopentane, dicyclopentadiene and 1,4-cyclohexadiene. Preferred are non-conjugated vinyl norbornenes and C₈-C₁₂ alpha omega linear dienes. (e.g., 1,7-octadiene, 1,8-nonadiene, 1,9-decadiene, 1,10-undecadiene, 1,11-dodecadiene). The dual polymerizable dienes may be further substituted with at least one group comprising a heteroatom of group 13-17 for example O, S, N, P, Cl, F, I, Br, or combinations thereof. Dual polymerizable dienes may cause or contribute to the formation of polymer branches.

In a preferred embodiment of the present disclosure the dual polymerizable diene is selected from, 2,5-norbornene, 5-vinyl-2-norbornene (VNB), 1,7-octadiene and 1,9-decadiene with 5-vinyl-2-norbornene (VNB) being most preferred. In one embodiment the copolymer of the present disclosure consists only of units derived from VNB as dual-polymerizable diene.

In a preferred embodiment of the present disclosure the EPDM polymer comprises a combination of ENB and one or more dual polymerizable dienes. Preferably, the copolymer of the present disclosure comprises not more than 5% by weight of dual polymerizable dienes. Preferably the polymer comprises from 0.05 wt. % to 5 wt. %, more preferably from 0.10 wt. % to 3 wt. %, or from 0.2 wt. % to 1.2 wt. % of units derived from the one or more dual polymerizable diene, more preferably from VNB (all weight percentages are based on the total weight of the polymer).

### Optional Comonomers

The EPDM polymer according to the present disclosure may or may not comprise units derived from other comonomers, for example, but not limited to, comonomers introducing functional groups into the polymer chain or are present as by-products or impurities. The amounts of units derived from such optional other comonomers is from 0% by weight up to 20% by weight, and preferably is from 0% to less than 10% or even less than 5% by weight. Typically, the sum of units derived from ethylene, non-conjugated diene(s) and α-olefin(s) is greater than 99 wt. %, and preferably is 100 wt. % based on the total weight of the EPDM polymer. In one embodiment of the present disclosure the sum of units derived from ethylene, propylene, ENB is higher than 75% by weight based on the total weight of the EPDM polymer, preferably greater than 90% by weight and more preferably at least 95% by weight.

### Polymer Properties

The EPDM polymer according to the present disclosure preferably has a high Mooney viscosity, for example a Mooney viscosity ML 1+8 at 150° C. of at least 80 or at least 90 or at least 100 and may in fact have a Mooney viscosity of even greater than 150. For example, the copolymer may have a Mooney viscosity ML 1+8 at 150° C. of 80 to 120 or of 80 to 150. Mooney viscosities ML 1+8 at 150° C. of greater than 150 cannot be measured reliably, therefore 150 is indicated as maximum measurable threshold and the Mooney viscosity may in fact be higher than 150.

The EPDM polymer according to the present disclosure preferably has a weight average molecular weight (Mw) of at least 400,000 g/mole, preferably at least 500,000 g/mole and more preferably at least 600,000 g/mole. For example, the polymer may have an Mw of between 400,000 g/mole and 700,000 g/mole.

In one embodiment of the present disclosure the number-averaged molecular weight (Mn) of the EPDM polymers of the present disclosure may be from about 70 to 300 kg/mole. Mw and Mn can be determined by gel permeation chromatography.

The EPDM polymer of the present disclosure may have a molecular weight distribution or polydispersity of at least 2.6, for example from 2.6 to 30, or from 3.5 to 25 or from 3.5 to 10.

The EPM polymer according to the present disclosure may be branched, for example with a branching level of Δδ between 2 and 50, more preferably with a Δδ between 5 and 35 or between 8 to 30, or between 10 to 25. Δδ, expressed in degrees, is the difference between the phase angle δ at a frequency of 0.1 rad/s and the phase angle δ at a frequency of 100 rad/s, as determined by Dynamic Mechanical Spectroscopy (DMS) at 125° C.

The EPDM polymer according to the present disclosure has an ENB content per polymer chain (EPC) of at least 80, preferably from 80 to 150, for example between 85 and 130, or from 90 to 125, or from 100 to 140. The ENB content per polymer chain can be calculated according to equation E1:

$$EPC = ( [ ENB ] \times 10 \times Polymer Mn ) / 120 g / mol , \qquad ( E1 )$$

wherein ‘[ENB]’ is the content of ENB units of the polymer in % by weight (based on the total weight of the polymer which is 100% by weight and “Polymer Mn” is the number average molecular weight of the polymer in kg/mol (120 g/mol is the molecular weight of ENB). The Polymer Mn indicates the number of polymer chain. The EPC indicates the number of ENB molecules per polymer chain.

The EPDM polymer according to the present disclosure may or may not be oil-extended. The oil-extended polymer may be obtained by mixing the polymer with oil during or after the polymerization process in the reaction medium and before removing the reaction medium. Preferably the one or more oil is added to the reaction solution after it has left the reaction vessel and/or after the polymerization reaction has been terminated to produce the oil-extended polymer and before the solvent of the reaction solution is removed. For example, the addition may take place after the polymerization reaction, but before the removal of volatiles, for instance before a steam stripper or a dry finishing extruder. Preferably the extender oil is blended with the polymer when it is dissolved or suspended in the reaction media, preferably coming from the polymerization reactor.

The amount of oil may range from 0 to 70 phr, for example but not limited to more than 0 and up to 60 phr. Therefore, there are also provided compositions comprising the polymer of the present disclosure that is either oil-extended or is not oil-extended. In one embodiment there is provided a composition comprising at least 90% by weight, preferably at least 95% by weight, based on the total weight of the composition which is 100%, of one or more than one polymer according to the present disclosure and one or more than one extender oil. Preferably, such compositions comprise from 0 to 70 phr, preferably from 0 to 50 phr of oil or from 0 to 40 phr of oil. The term “phr” refers to parts per hundred parts of rubber. Preferably, the extender oil comprises one or more hydrocarbon-based oil(s). Any oil that is known in the art of producing rubbers as ‘extender oil’ can be used. The oil, preferablyl comprises one or more hydrocarbon-based oil(s) or is hydrocarbon-based oil or a mixture thereof. “Hydrocarbon-based” means the oil contains at least 50% by weight based on the total composition of the oil of hydrogen and carbon. The hydrocarbon-based oil may contain preferably at least 90% by weight, more preferably at least 95% by weight of carbon and hydrogen. Preferably the oil is liquid at 25° C. and atmospheric pressure (1 atm). Examples of suitable oils include hydrocarbon-based oils, for example those obtained from high boiling fractions from petroleum. Specific examples include oils based mainly on alkanes and/or cycloalkanes like paraffinic oils, naphthenic oils, mineral oils. Suitable oils also include aromatic oils for example those obtained from boiling fractions of petroleum. The oils generally show a dynamic viscosity of from 5 to 35 mm²/s at 100° C. Preferred oils include paraffinic oils. Suitable oils are commercially available for example under the trade designation PLI PROCESS OIL P 460SUNPAR 2280, available from Sunoco, CONOPURE 12P, available from ConocoPhillips, PARALUX 6001 available from Chevron Texaco. Other examples include oils made via a gas to liquid (GTL) process, like e.g. RISELLA X 430 from Shell. Other oils include those that contain olefin oligomers, for example homo-oligomers or co-oligomers of olefins, preferably alpha-olefin oligomers. In one embodiment the oil contains one or more alpha olefin oligomer or polymer and exhibits one or more of the following properties: a. a viscosity at a temperature of 190° C. (Brookfield Viscosity) of 90,000 mPa.sec or less or 80,000 or less, or 70,000 or less, or 60,000 or less, or 50,000 or less, or 40,000 or less, or 30,000 or less, or 20,000 or less, or 10,000 or less, or 8,000 or less, or 5,000 or less, or 4,000 or less, or 3,000 or less, or 1,500 or less, or between 250 and 15,000 mPa.sec, or between 500 and 5,500 mPa.sec, or between 500 and 3,000 mPa.sec; and/or
b. a viscosity at a temperature of 60° C. from 200 mPa.sec to 20.000 mPa.sec, from 400 to 20.000 mPa.sec or from 500 to 20.000 mPa.sec or from 1,000 to 10.000 mPa.sec determined according to ASTM D3236. In one embodiment, the olefin oligomers are reactive with the polymer during the polymerization and may be incorporated into the polymer chain during the polymerization process.

### Polymer Preparation

The EPDM polymers according to the present disclosure can be prepared by a process comprising copolymerizing ethylene, the at least one C₃-C₂₀-α-olefin and the at least one non-conjugated diene as known in the art of producing ethylene-copolymers. The polymers may be produced by using conventional catalysts, like for example Ziegler-Natta-catalysts or metallocene-type catalysts or post metallocene catalysts or by a combination of catalysts. Ziegler-Natta catalysts are non-metallocene type catalysts based on halides of transition metals, in particular titanium or vanadium. Metallocene-type catalysts are organometallic catalysts wherein the metal is bonded to at least one cyclic organic ligand, preferably at least one cyclopentadienyl or at least one indenyl ligand. In one embodiment a Ziegler-Natta catalyst is used. In another embodiment, preferably a metallocene-type catalyst is used. In another embodiment a combination of two or more metallocene-type catalysts is used. Preferably, the polymers are prepared by solution polymerization. Preferably, the polymer is not prepared by slurry polymerization. In one embodiment the EPDM polymer is produced by solution polymerization using a single polymerization catalyst. Typically, such reaction leads to monomodal polymers. Monomodal polymers typically show only a single maximum in the GPC. In one embodiment of the present disclosure the EDPM polymer is a monomodal polymer, for example of monomodal polymer showing only a single maximum in the GPC trace. In one embodiment the EPDM polymer is a bimodal polymer and shows at least two maxima in the GPC or one maximum and at least one should. In one embodiment the EPDM polymer is prepared by a catalyst system comprising two or more polymerization catalyst systems, for example as described in WO2020058267A1. Typically, the polymerization using at least two polymerization catalysts can lead to the formation of bimodal or other multimodal EPDM polymers.

The polymerisation can take place in different polymerization zones. A polymerization zone is a vessel where a polymerization takes place and could be either a batch reactor or a continuous reactor. When multiple reactors are employed (for example multiple reactors connected in series or in parallel), each reactor is considered as a separate polymerisation zone. Preferred solvents include one or more hydrocarbon solvent. Suitable solvents include C₅₋₁₂ hydrocarbons such as pentane, hexane, heptane, octane, cyclohexane, methylcyclohexane, pentamethyl heptane, hydrogenated naphtha, isomers and mixtures thereof. The polymerization may be conducted at temperatures from 10 to 250° C., depending on the product being made. Most preferably the polymerisation is performed at temperatures greater than 50° C.

The ENB content per polymer chain (EPC) can be controlled, for example, by the amount of ENB used in the polymerization reaction. The EPC is further controlled by the length of the polymer chain for which the number-averaged molecular weight (Mn) is indicative. The number-averaged molecular weight typically increases with the molecular weight of the polymer. The length of the polymer chains can be further controlled by using chain transfer agents and/or by introducing long chain branching. A preferred chain transfer agent includes hydrogen (H₂). Long chain branching can be introduced as known in the art, for example by using specific polymerization catalyst systems that create branches in the polymer, for example catalysts that create or favour the formation of vinyl groups, or by using monomers that create polymer branching, for example the dual polymerizable dienes described above, for example VNB.

### Polymer Blends

It has been found that the same properties as a single polymer according to the present disclosure can be achieved by blends comprising a first EPDM polymer and a second EPDM polymer and wherein the blend has an ENB content per polymer chain (EPC) of at least 80, preferably from 80 to 150, for example between 85 and 130, or from 90 to 125 or from 100 to 140. The EPC for the blends can be determined according to equation (1) by using the Mn obtained for the blend and the ENB content of the blend. To compose such blends and to reach the appropriate EPC of the blend the first and second EPDM polymer are used in weight ratios according to their own EPC's: EPC of the blend=(wEPDM1×EPC1)+(wEPDM2×EPC2). wEPDM1 is the weight fraction of the first EPDM polymer and wEPDM2 is the weight fraction of the second EPDM polymer. The sum of wEPDM1 and wEPDM2 equals 1.0. For a blend with 50 wt % of EPDM1 and 50 wt % EPDM 2 the wEPDM1 and wEPDM2 are both 0.5.

The first EPDM polymer comprises from 59% to 70% by weight of units derived from ethylene, preferably from 60% by weight to 68% by weight or from 61% by weight to 67% by weight of units derived from ethylene. The “% by weight” are based on the total weight of the first polymer. In addition to units derived from ethylene, the first EPDM polymer according to the blend composition of the present disclosure comprises units derived from (i) one or more C₃-C₂₀-α-olefin as described above, preferably propylene, and (ii) units derived from at least one non-conjugated diene as described above. Preferably, the first EPDM polymer comprises from 1% to 20% by weight based on the total weight of units derived from one or more non-conjugated diene. Preferably, the first EPDM polymer comprises units derived from ENB, DCPD or a combination thereof, and preferably in addition also units derived from VNB. The first EPDM polymer comprises at least 17% by weight of units derived from propylene. The first EPDM polymer according to the present disclosure preferably has a weight average molecular weight (Mw) of at least 400,000 g/mole, preferably at least 500,000 g/mole and more preferably at least 600,000 g/mole. For example, the first EPDM polymer may have an Mw of between 400,000 g/mole and 700,000 g/mole.

The second EPDM polymer comprises from 35% to 65% by weight of units derived from ethylene, preferably from 35 to 58% by weight, and further comprises at least 17% by weight of units derived from propylene. The second EPDM polymer further comprises units derived from and at least one non-conjugated diene selected from ENB, VNB, DCPD or a combination thereof. The % by weight is based on the total weight of the second EPDM polymer.

The first EPDM polymer, second EPDM polymer or both may comprise one or more optional comonomers as described above. The amounts of units derived from such optional other comonomers is from 0% by weight up to 20% by weight, and preferably is from 0% to less than 10% or even less than 5% by weight based on the total weight of the blend. Typically, the sum of units derived from ethylene, non-conjugated diene(s) and α-olefin(s) is greater than 99 wt. %, and preferably is 100 wt. % based on the total weight of the blend. The first EPDM polymer, the second EPDM polymer or both may or may not be oil-extended. The first EPDM polymer may be the same as the EPDM polymer of the polymer composition described above.

The polymer blends according to the present disclosure comprising the first and the second EPDM polymer have a total content of units derived from one or more non-conjugated dienes of from 7.5 to 20% by weight based on the total weight of the blend and comprise from 6.0% and up to 20% by weight of units derived from ENB, preferably from 7.0% by weight to 15.0% by weight of units derived from ENB (based on the total weight of the blend).

The blends may be reactor blends but preferably the polymer blend composition is a dry blend. Preferably, the weight ratio of first EPDM polymer to the second EPDM polymer is from 3:1 to 1:3, preferably 2:1 to 1:2 or from 1.3 to 0.7 to 0.7 to 1.3.

In one embodiment of the present disclosure the blends may comprise at least 90% by weight, preferably at least 95% by weight, based on the total weight of the blends of first and second polymer and extender oil.

The blend of first and second EPDM polymers according to the present disclosure preferably has a high Mooney viscosity, for example a Mooney viscosity ML 1+8 at 150° C. of at least 80 or at least 90 or at least 100 and may in fact have a Mooney viscosity of even greater than 150. For example, the copolymer may have a Mooney viscosity ML 1+8 at 150° C. of 80 to 120 or of 80 to 150.

The blend composition according to the present disclosure preferably has a molecular weight distribution of greater than 3, preferably greater than 3.5, for example from 3.5 to 25 or from 3.5 to 10. The MWD of the blend is the ratio of the Mw and Mn as they are calculated from the measured GPC traces.

### Rubber Compounds

The polymer compositions according to the present disclosure and the blends according to the present disclosure may be combined with one or more additional ingredients to produce curable rubber compounds. Such additional ingredients include but are not limited to (a) one or more than one curing agent, (b) one or more than on filler, (c) one or more than one rubber auxiliaries. In rubber compounds, typically, the content of ingredients other than the polymer composition or the polymer blend according to the present disclosure is at least 10 wt. % based on the total weight of the composition. The rubber compounds are curable and can be cured to provide vulcanized compounds or “vulcanizates”.

Therefore, in one embodiment there is provided a rubber compound comprising (i) either the polymer composition according to the present disclosure or the polymer blend according to the present disclosure, (ii) one or more than one curing agent, (iii) one or more than one filler, (iv) one or more than one rubber auxiliaries and wherein the total content of (ii), (iii) and (iv) is at least 10% by weight, preferably at least 15% by weight or at least 20% by weight, based on the total weight of the rubber compound which is 100%. The content of (i) is also at least 10% by weight based on the total weight of the rubber compound.

### Curing Agents

Suitable curing (vulcanizing) agents include but are not limited to sulfur, sulfur chloride, sulfur dichloride, 4,4′-dithiodimorpholine, morpholine disulfide; alkylphenol disulfide, tetramethylthiuram disulfide (TMTD), tertaethylthiuram disulfide (TETD), selenium dimethyldithiocarbamate, and organic peroxides. Organic peroxides include but are not limited to dicumyl peroxide (DCP), 2,5-di(t-butylperoxy)-2,5-dimethyl-hexane (DTBPH), di(t-butylperoxyisopropyl)benzene (DTBPIB), 2,5-di(benzoylperoxy)-2,5-dimethylhexane, 2,5-(t-butylperoxy)-2,5-dimethyl-3-hexyne (DTBPHY), di-t-butyl-peroxide and di-t-butylperoxide-3,3,5-trimethylcyclohexane (DTBTCH) or mixtures of these peroxides. Of these, preferred are sulfur, TMTD, TETD, DCP, DTBPH, DTBPIB, DTBPHY and DTBTCH.

In case of sulfur vulcanization, sulfur or a sulfur-containing curing agent is preferably used in an amount of 0.1 to 10 phr, preferably from 0.5 to 5 phr or even more preferably 0.5 to 2 phr. In case of peroxide vulcanization, the organic peroxide-based curing agent may be used in an amount from 0.1 to 15 phr, preferably from 0.5 to 5 phr.

Sulfur as vulcanizing agent may be used in combination with one or more vulcanization accelerators and one or more vulcanization activators. Examples of the vulcanization accelerators include but are not limited to N-cyclohexyl-2-benzothiazole-sufenamide, N-oxydiethylene-2-benzothiazole-sulfen-amide, N,N-diisopropyl-2-benzothiazole-sulfen-amide, 2-mercaptobenzothiazole, 2-(2,4-dinitrophenyl)mercaptobenzothiazole, 2-(2,6-diethyl-4-morpholinothio)benzothiazole, dibenzothiazyl-disulfide, diphenylguanidine, triphenylguanidine, di-o-tolylguanidine, o-tolyl-bi-guanide, diphenylguanidine-phthalate, an acetaldehyde-aniline reaction product, a butylaldehyde-aniline condensate, hexamethylenetetramine, acetaldehyde ammonia, 2-mercaptoimidazoline, thiocarbaniride, diethylthiourea, dibutylthiourea, trimethylthiourea, di-o-tolylthiourea, tetramethylthiuram monosulfide, TMTD, TETD, terabutylthiuram disulfide, dipentamethylenethiuram tetrasulfide, zinc dimethyldithiocarbamate, zinc diethyl-thiocarbamate, zinc di-n-butylthiocarbamate, zinc ethylphenyldithiocarbamate, zinc butylphenyldithiocarbamate, sodium dimethyldithlocarbamate, selenium dimethyldithiocarbamate, tellurium diethyldithiocarbamate, zinc dibutylxanthate and ethylenethiourea. The vulcanization accelerators, if used, are used preferably in an amount of from 0.1 to 10 parts by weight, and more preferably from 0.2 to 5 parts by weight and most preferably between 0.25 and 2 phr per 100 parts by weight of the ethylene-copolymer.

Examples of the vulcanization activators include but are not limited to metal oxides, such as magnesium oxide and zinc oxide, stearic acid or its metal salts stearic acid or combinations thereof like, for example zinc oxide combined with stearic acid. The vulcanization activators are used usually in amounts from 0.5 to 10 phr based on the ethylene copolymer, preferably in amounts from 0.5 to 5 phr.

When peroxide or a mixture of peroxides is used as the vulcanizing agent, peroxide cross-linking coagents may be used. Examples of such peroxide cross-linking coagent are cyanurate compounds, such as triallyl cyanurate and triallylisocyanurate, (meth)acrylate compounds, such as trimethylolpropane-trimethacrylate and ethyleneglyclol-dimethacrylate, zinc-dimethacrylate and zincdiacrylate, divinylbenzene, p-quinonedioxime, m-phenylene dimaleimide, (high vinyl) polybutadiene, and combinations thereof. Preferably, 0.1 to 5 phr of the peroxide cross-linking coagents may be used. More preferably from 0.25 to 2.5 phr of peroxide cross-linking coagent may be used. When peroxides are used as the vulcanizing agent in addition, preferably sulphur (elementary or as part of sulphur accelerators or sulphur donors) can be used to obtain so-called hybrid curing systems. These curing systems combine high heat resistant properties, typical for peroxide cure, with very good ultimate properties, such as tensile and tear, as well as excellent dynamic and fatigue properties typically associated with sulphur vulcanization systems. Applied dosing levels of sulphur are preferably from 0.05 to 1.0 phr, preferably from 0.2 to 0.5 phr.

### Fillers

Preferably the filler may be used in an amount of 20 to 500 phr. Preferred fillers include carbon-based filler, for example carbon blacks, and silica-based fillers and a combination thereof. Fillers also include calcium carbonates, talcum and clays which are conventionally used for rubber. The type of carbon black is classified according ASTM D-1765 for its particle size (BET in m²/g) and structure (DBP adsorption in cm³/100 g). Preferably carbon black fillers are used having a BET number from 5 to 150, and DBP numbers from 30 to 140. In the industry these types of carbon blacks are often designated to by abbreviations, such as MT, SRF, GPF, FEF, HAF, ISAF, SAF. The inorganic fillers may be surface treated with suitable silanes. Combinations of two or more of such fillers may be used. Most preferably the filler comprises carbon black and/or silanized silica.

Further fillers may include one or more than one other rubber, including EPDM rubbers other than those as claimed, and rubber blends.

### Other Rubber Additives (Rubber Auxiliaries)

Other rubber additives include those commonly used in the art of rubber compounding. Examples include but are not limited to antioxidants (e.g., hindered phenolics such as commercially available under the trade designation IRGANOX 1010 or IRGANOX 1076 from BASF; phosphites (for example those commercially available under the trade designation IRGAFOS 168, dessicants (e.g. calcium oxide), tackifiers (e.g. polybutenes, terpene resins, aliphatic and aromatic hydrocarbon resins, alkali metal and glycerol stearates, and hydrogenated rosins and the like), bonding agents, heat stabilizers; anti-blocking agents; release agents; anti-static agents pigments; colorants; dyes, processing aids (e.g. factice, fatty acids, stearates, poly-or di-ethylene glycols), antioxidants, heat stabilisers (e.g. poly-2,2,4-trimethyl-1,2-dihydroquinoline or zinc 2-mercaptobenzimidazole), UV stabilisers, anti-ozonants, blowing agents and mould releasing agents, partitioning agents or processing aids like talc or metal salts, such as e.g. zinc stearate, magnesium stearate or calcium stearate and plasticizers (plasticizer lubricating oil, for example those commercially available under the trade designation PLI PROCESS OIL P460, paraffin, liquid paraffin, petroleum asphalt, vaseline, low molecular weight polyisobutylene or polybutylene, liquid EPDM or EPM, coal tar pitch, castor oil, linseed oil, beeswax, atactic polypropylene and cumarone indene resin). Plasticizers may be used in amounts from 20 to 250 phr. Rubber auxiliaries include plasticizers which may comprise one or more oil and the overall oil content in the rubber compounds may be higher than in the compositions used to make the compounds. Further additives as known in the art may also be used.

### Process of Making Rubber Compounds

Rubber compounds can be manufactured by mixing the polymer composition according to the present disclosure or the blend composition according to the present disclosure with a) one or more one or more curing agents described above, b) one or more filler described above and/or c) one or more rubber auxiliaries described above. The mixing preferably comprises kneading, for example with conventional rubber mixing equipment including, for example, kneaders, open roll mills, internal mixers, or extruders. Mixing can be done in one or more steps as known to the person skilled in the art.

### Articles and Applications

To produce articles the curable (vulcanizable) rubber compounds are subjected to at least one shaping step and are shaped, for example by extruding and/or moulding, and to at least one vulcanization step. The vulcanization may take place before, during or after shaping, for example during or after extrusion or moulding. Articles made by using the ethylene-copolymer according to the present disclosure contain the polymer in cured form, i.e. the polymer is cross-linked either with itself or with other cross-linkable ingredients in the compound or composition used to make the article, for example other curable rubbers.

Therefore, in one aspect there is provided a vulcanized rubber compound or a composition comprising it, wherein the vulcanized rubber compound comprises the reaction product of a curing reaction wherein the rubber compound described above or a composition comprising it has been subjected to at least one curing reaction.

In another aspect, there is provided a method of making an article comprising subjecting a rubber compound according to the present disclosure to shaping and curing, wherein shaping can be done after, prior to, or simultaneous with the curing.

There is also provided an article obtained by this method. The polymer compositions and polymer blends according to the present disclosure may be used in a variety of end-use applications and articles. They are particularly suitable for dynamic applications, i.e., applications where shaped parts are subjected to repeated stress forces and dynamic loading. Typical dynamic applications include engine mounts, flexible couplings and torsional vibration dampers, belts, muffler hangers, air springs and bridge bearings. Therefore, there are also provided engine mounts, flexible couplings, torsional vibration dampers, belts, muffler hangers, air springs and bridge bearings comprising the rubber compound or vulcanized rubber compound described above.

The disclosure will now be further illustrated by way of examples but with no intention to limit the disclosure to these examples and the embodiments used in the examples.

### EXAMPLES

### Test Methods

### Polymer Testing

### Polymer Composition:

Fourier transformation infrared spectroscopy (FT-IR) was used to determine the composition of the copolymers according to ASTM D 3900 for the C2/C3 ratio and D 6047 for the ENB content, i.e. units derived from ENB, on pressed polymer films. The total polymer composition was then calculated from the values obtained from both methods.

### Branching, Δδ:

Polymer branching level was characterized by the parameter Δδ. Δδ, expressed in degrees, is the difference between the phase angle δ at a frequency of 0.1 rad/s and the phase angle δ at a frequency of 100 rad/s, as determined by Dynamic Mechanical Spectroscopy (DMS) at 125° C. and 10% strain. This quantity Δδ is a measure for the amount of long chain branched structures present in the polymer and has been introduced in H.C. Booij, Kautschuk+Gummi Kunststoffe, Vol. 44, No. 2, pages 128-130, which is incorporated herein by reference.

### Molecular Weights and Molecular Weight Distribution:

The molecular weight of the polymer (Mw), the number-averaged molecular weight of the polymer (Mn), the z average molecular weight (Mz) and the molecular weight distribution (MWD; Mw/Mn) were determined by gel permeation chromatography. Universal calibration of the system was performed with polyethylene (PE) standards. Elution was carried out with TCP (1,2,4-tri-chlorobenzene) at 160° C.

Gel permeation chromatography (GPC/SEC-DV) was carried out using a Polymer Char GPC from Polymer Characterisation S.A. Valencia, Spain. The Size Exclusion Chromatograph was equipped with an on-line viscometer (Polymer charV-400 Viscometer), an online infrared detector (IR% MCT), with 3 AGILENT PL OLEXIS columns (7.5×300 mm) and a Polymer Char autosampler. The polymer samples were weighted (in the concentration range of 0.3 to 1.3 mg/ml) into the vials of the PolymerChar autosampler. In the autosampler the vials were filled automatically with solvent (1,2,4-tri-chlorobenzene, TCB) stabilized with 1 g/l di-tert-butyl-paracresol (DBPC). The samples were kept in the high temperature oven (160° C.) for 4 hours. After this dissolution time, the samples were automatically filtered by an in-line filter before being injected onto the columns. The chromatograph system was operated at 160° C. The flow rate of the TCB eluent was 1.0mL/min. The chromatograph contained a built-in on-line infrared detector (IR5 MCT) for concentration and built-in PolymerChar on-line viscometer.

### Mooney Viscosity:

The Mooney viscosity was measured according to ISO 289.

### Oil Content:

The oil content can be determined by extraction, for example, according to ISO1407 from 2011, method D for non-vulcanized rubbers and method A for vulcanized rubbers.

### Compound Testing

### Mooney Viscosity:

Mooney viscosity (measuring conditions ML(1+4) @ 100° C.) of the curable compounds was determined according to DIN 53523-3 using NatureFlex NP/28 μm film manufactured by Putz Folien, D-65232 Taunusstein Wehen, Germany.

### Compression Set (CS):

The compression set (CS) were determined on cured compounds according to DIN ISO 815.

### Tensile Strength at Break (TS) and Elongation at Break (EB):

The tensile strength at break (TS) and the elongation at break (EB) were determined on a S2 dumbell at 23° C. on cured compounds according to DIN ISO 37.

### Hardness:

The shore A hardness (H) was determined on cured compounds according to DIN ISO 7629-1.

### Rebound:

Rebound resilience was measured at 23° C. according to DIN 53512.

### Tan Delta and Dynamic Stiffness:

A dynamic-mechanical analyser from MTS Systems Cooperation was used. Two test specimens (6 mm in height and 20 mm diameter) were placed into a double shear sandwich sample holder and equilibrated at 60° C. for at least 30 min before the measurement was started. Thereafter, the linear viscoelastic properties of the rubber material were probed in simple shear geometry for frequencies in the range from 0.1 to 200 Hz (logarithmic scaling with 8 data points per decade) applying a peak-to-peak amplitude of 0.3 mm. Tan delta was determined at 200 Hz. The dynamic stiffness, DS, was obtained from the ratio of the 5 absolute moduli measured at 180 Hz and 10 Hz: DS=|G*(180 Hz)|/|G*(10 Hz)|.

### Tear Strength:

ISO 34-2 was applied measuring the tear resistance with Delft test specimens at 23° C.

### Comparative Examples C0 to C10

Various EPDM polymers were compared for their composition and properties of cured compounds obtained from them. The polymers had the properties and composition as shown in table 1.

TABLE 1
comparison of the comparative polymers C0 to C5A.

| Property | Unit | C0 | C1 | C2 | C3 | C4 | C5 | C5A |
|---|---|---|---|---|---|---|---|---|
| ML(1 + 8)150° C. | MU | 94 | 52 | 62 | 48 | 54 | 56 | 81** |
| ML(1 + 4)125° C. | MU | | 81 | 96 | 74 | 83 | | |
| Δδ | ° | 17 | 14 | 13 | 15 | 11 | 4 | |
| Units derived | % | 44.4 | 55.2 | 51.6 | 48.8 | 57.1 | 55.0 | 54** |
| from ethylene^{#} | | | | | | | | |
| Units derived | % | 8.5 | 10.6 | 9.8 | 10.2 | 8.4 | 9.5 | 8.5** |
| from ENB | | | | | | | | |
| Units derived | % | 0.46 | n.d. * | n.d. * | n.d. * | n.d. * | 0.73 | |
| from VNB | | | | | | | | |
| Oil | phr | 15 | 0 | 0 | 15 | 0 | 20 | |
| Mn | kg/mol | 155 | 84 | 75 | 88 | 70 | 66 | 67 |
| Mw | kg/mol | 620 | 310 | 340 | 410 | 310 | 420 | 460 |
| Mz | kg/mol | 1900 | 1300 | 1290 | 1800 | 1400 | 2000 | |
| MWD | | 4.0 | 3.7 | 4.5 | 4.7 | 4.4 | 6.4 | 6.9 |
| ENB/chain | units | 110 | 74 | 61 | 75 | 49 | 52 | 48 |
| (EPC) | | | | | | | | |
| δₘᵢₙ | ° | 2.98 | 4.29 | 4.35 | 4.35 | 5.09 | 4.80 | |

* n.d. = not detected; detection limit <0.04%;
**= ML(1 + 4)at 150° C. according to data sheet;
***according to data sheet. The content of units derived from propylene is not indicated in table 1 but makes up the rest of the polymer and can be calculated by 100% minus the total content of the units derived from ethylene, ENB and VNB. C1 to C5A were commercial products and data was taken from public data sheets or determined experimentally. In case the C2 content was taken from data sheets the C2 content may be determined from the C2/C3 ratio only and may not have been corrected for the ENB content. C1 was an EPDM sample available under the trade designation ROYALENE 547 from Lion Copolymer Geimar, LLC; C2 was an EPDM sample available under the trade designation KEP2480 from KUMHO POLYCHEM; C3 was an EPDM sample available under the trade designation VISTALON 8800 from ExxonMobil; C4 was an EPDM sample available under the trade designation VISTALON 8700 from ExxonMobil; C5 was an EPDM sample available under the trade designation EPT8120E from Mitsui Chemical Inc; C5A was an EPDM sample available under the trade designation ESPRENE 5527F from SumitomoChemical.

The following additional commercial samples available under the trade designations as indicated were analyzed for the content of units derived from ENB per polymer chain: KELTAN K8340A and KELTAN K7341A from ARLANXEO Netherlands B.V.: ENB per polymer chain: 44 and 63, respectively. VISTALON 7500 from Exxon Mobil Corporation: ENB per polymer chain: 34.

The polymers of example C0 to C5 were compounded with the ingredients shown in table 2 by an internal mixer (GK1,5 E1 from Harburg-Freudenberger Maschinenbau GmbH; ram pressure 8 bar, 50 rpm, 72% degree of filling and total mixing time 5 min). The curing system was added on an open mill (200 mm roll diameter; 20 rpm, 40° C. roll temperature and friction).

TABLE 2
ingredients used for making EPDM rubber compounds.

| Ingredient | Amount, phr |
|---|---|
| EPDM polymer | 100 |
| Zinc oxide | 5 |
| Stearic acid | 2 |
| Carbon black | 50 |
| Oil | 45 |
| RHENOGRAN S-80 (80% sulfur) | 0.64 |
| RHENOGRAN TMTD-70 | 1.25 |
| (70% tetramethylthiuram disulfide) | |
| RHENOGRAN MBT-80 (80% | 0.42 |
| 2-mercaptobenzothiazole) | |
| Total loading | 204.31 phr |

The resulting EPDM compounds were tested for compound properties. Comparative Example C5B is the compound made with the polymer of comparative example C0.

Comparative examples C6 to C10 are the compounds obtained with polymers of comparative examples C1 to C5.

Test specimens were prepared by curing test plates of 2 mm and 6 mm thickness at 180° C. for a time equivalent to 1.10 and 1.25 times t90 (t90 is the time to reach 90% of maximum torque during the rheometer measurement). The test results are shown in table 3.

TABLE 3
results of compound testing.

| Property | Unit | C5B | C6 | C7 | C8 | C9 | C10 |
|---|---|---|---|---|---|---|---|
| Compound ML | MU | 80 | 48 | 47 | 51 | 45 | 58 |
| ΔS | dNm | 8.4 | 8.6 | 7.3 | 7.8 | 8.0 | 7.4 |
| Hardness | ShoreA | 48 | 46 | 45 | 45 | 46 | 45 |
| Tensile Strength | MPa | 15.9 | 18.1 | 18.7 | 15.6 | 19.2 | 14.2 |
| Elongation at | % | 637 | 675 | 724 | 677 | 727 | 537 |
| break | | | | | | | |
| Tear Strength | MPa | 23 | 24 | 24 | 23 | 26 | 23 |
| Tan delta | — | 0.148 | 0.180 | 0.182 | 0.168 | 0.185 | 0.178 |
| Dynamic stiffness | — | 1.24 | 1.29 | 1.31 | 1.26 | 1.32 | 1.31 |
| Rebound 23° C. | % | 66.4 | 62.3 | 61.5 | 61.1 | 59.6 | 60.9 |
| Rebound 60° C. | % | 66.5 | 62.5 | 62.5 | 65.5 | 61.0 | 62.5 |
| CS 72 h/23° C. | % | 7 | 9 | 11 | 9 | 13 | 11 |

As can be seen from tables 1 and 3, the elastic properties (tan delta) and the dynamic stiffness improved with increased ENB content per polymer chain as indicated by lower values.

### Comparative Example 11 and Examples 1 to 3 (Single Polymers)

Comparative Example 11 corresponds to Example 1 of WO2014/206952A1. This polymer was prepared by slurry polymerization. The polymer of examples 1 to 3 were prepared by solution polymerization with a metallocene-type catalyst as described in general in international patent application WO2005/090418A1 (Ipeij et al), incorporated herein by reference. Ethylene and ENB feed, MW, MWD, and use of chain transfer agents were adjusted to obtain high molecular weight polymers with high C2 content and a DCP value within 80 to 150. The polymers of comparative example 11 and examples 1 to 3 were oil-extended and contained about 50 phr extender oil. The polymer data are shown in table 4. The polymers were compounded into rubber compounds using the formulation shown in table 5. The compound properties are shown in table 6.

TABLE 4
Polymer compositions

| | C11 | Ex 1 | Ex 2 | Ex 3 |
|---|---|---|---|---|
| C2 content (% wt) | 62 | 62.97 | 64.66 | 65.85 |
| ENB content (% wt) | 5.5 | 7.65 | 7.23 | 9.06 |
| VNB content (% wt) | | 0.35 | 0.38 | 0.11 |
| Extender oil | 35 | 32.16 | 32.85 | 32.44 |
| Δδ | | 15.2 | 16.0 | |
| ML(1 + 8) at 150° C. (MU) | >50 | >50 | >50 | >50 |
| Mn (kDA) | 207* | 210 | 155 | 170 |
| Mw (kDA) | 470* | 540 | 690 | 620 |
| Mz (kDA) | | 1100 | 2300 | 1700 |
| Mw/Mn | 2.3 | 2.6 | 4.4 | 3.6 |
| ENB/chain (EPC) | 95 | 134 | 93 | 128 |

The remainder of the polymer is made up of units derived from propylene.

TABLE 5
Ingredients of rubber compounds.

| Ingredient | Amount, phr |
|---|---|
| EPDM polymer | 150* |
| EDENOR C18C-98 MY | 1 |
| VULCANOX HS/LG | 0.75 |
| VULCANOX ZMB2-C5 | 1 |
| Ground sulfur 90-95° | 0.3 |
| Zinc oxide | 5 |
| Carbon black (CORAX N550/30) | 50 |
| PLI Process Oil P 460 | 5 |
| RHENOGRAN S-80 (80% sulfur) | 0.35 |
| RHENOGRAN TMTD/C | 0.88 |
| RHENOGRAN MBT-80 (80% 2- | 0.42 |
| mercaptobenzothiazole) | |

*all polymers were oil-extended, oil content was about 50 phr.

TABLE 6
rheological and dynamic properties of compounds

| | C0 | Ex 3 | Ex 1 | Ex 2 |
|---|---|---|---|---|
| ML 1 + 4 | 67 | 87.6 | 94.2 | 99.3 |
| Shore A | 49.43 | 55.87 | 50.3 | 53.73 |
| EAB (%) | 725 | 681 | 685 | 660 |
| TAB (MPa) | 27.5 | 32.2 | 31.1 | 32.1 |
| tan delta max | 0.14 | 0.12 | 0.13 | 0.13 |
| Dynamic stiffening | 1.19 | 1.17 | 1.20 | 1.19 |

A comparison of examples 1 to 3 with comparative example 11 shows that similar or even lower tan delta values but at broader molecular weight distributions if the ENB content is increased and the ENB content per polymer chain is kept within the range of 80 to 150, preferably 100 to 150. This means the polymer architecture allows to broaden the molecular weight distribution and thus increases the processing window at which the polymers can be processed and loaded with fillers without reducing the elastic and dynamic properties of the compound.

### Examples 4 to 7: Polymer Blends

Blends were prepared from two different EPDM polymers (examples 4 and 5). The EPDM polymers of Examples 4 and 5 were prepared by solution polymerization similar as described for examples 1 to 3. Their composition is described in table 7. Blends were made from these polymers as shown in table 8 by combining the polymers such that the EPC content of the blend was in the range of 80 to 150, preferably 100 to 150. The blends were compounded to rubber compound (Examples 6 and 7) with the ingredients shown in table 9 and according to the mixing protocol described below. The blends were compared with comparative example 12, which was a compound made with a polymer of comparative example 11. The properties of the rubber compounds are shown in table 10.

TABLE 7
polymer composition

| | C2 (wt %) | ENB (wt %) | Oil (phr) | Mn (kg/mol) | EPC |
|---|---|---|---|---|---|
| Example 4 | 62 | 8.7 | 100 | 171 | 124 |
| Example 5 | 44 | 9 | 15 | 142 | 107 |
| Comparative | 62 | 5.5 | 50 | 205 | 94 |
| example 11 | | | | | |

TABLE 8
Composition of polymer blends

| | Comparative | Example | Example |
|---|---|---|---|
| | Example 12 | 6 | 7 |
| Polymer of Comparative | 100 | | |
| Example 11 | | | |
| Weight ratio: | | 50:50 | 60:40 |
| polymer of Ex 4:polymer of Ex 5 | | | |
| Average C2 (wt) % | 62 | 53 | 55 |
| Average ENB (wt %) | 5.5 | 8.9 | 8.8 |
| ENB content per polymer | 94 | 116 | 117 |
| chain (EPC) | | | |
| Average oil (phr) | 50 | 57.5 | 66 |
| Added oil (phr) | 15 | 7.5 | 0 |
| Total oil (phr) | 65 | 65 | 66 |

TABLE 9
Ingredients of rubber compounds and their amounts in phr

| | | | |
|---|---|---|---|
| CE12 | | | 150 |
| EX 6 | 100 | 120 | |
| EX 7 | 57.5 | 46 | |
| SVR CV60 | 5 | 5 | 5 |
| RU CORAX N 550* | 40 | 40 | 40 |
| PLI PROCESS OIL P460* | 7.5 | | 15 |
| PALMERA A9818* | 1.5 | 1.5 | 1.5 |
| ZINKOXYD AKTIV* | 5 | 5 | 5 |
| VULKANOX HS/LG* | 0.75 | 0.75 | 0.75 |
| VULKANOX ZM B2/CS* | 1 | 1 | 1 |
| RHENOGRAN CBS-80** | 2.5 | 2.5 | 2.5 |
| RHENOGRAN TBZTD-70** | 2.875 | 2.875 | 2.875 |
| RHENOGRAN S-80** | 1.25 | 1.25 | 1.25 |
| Total | 224.9 | 225.9 | 224.9 |

*added in step 2 of the protocol,
**added on mill.

### Mixing Protocol:

The ingredients were mixed in a 1.5 litre GK intermeshing internal mixer, using the following sequence.
Step 1; Add polymers, lower ram and blend for 30 seconds.
Step 2; Add all ingredients excluding the cure system, mix to 70° C., raise ram and sweep, close ram and continue mixing to 300 seconds. Drop batch from mixer and transfer to a 2-roll mill.
Mill; Roll temperature 50° C., front roll speed 20rpm. Add and incorporate the cure system. Cut and blend three times, pass the compound end-ways-on through a tight nip three time, sheet off at 5 mm thickness.

Test pieces were cured by compression moulding according to MDR t90+10% at 180° C. for 2 mm thick test sheets and MDR t90+25% at 180° C. for 6 mm thick hardness test pieces. Dynamic properties were determined on 6 mm thick test buttons by MTS frequency sweep of 0.1Hz to 200Hz at both 100° C. and 60° C. and an amplitude of 3% (table 8). Storage modulus (G′), loss modulus (G″), tan delta and dynamic stiffness were virtually identical for all compounds across the full frequency range. Dynamic stiffness was also similar for all compounds at both test temperatures.

TABLE 10
Compound properties

| | Comparative | | |
|---|---|---|---|
| | Example 12 | Example 6 | Example 7 |
| ML 1 + 4/MU | 64.41 | 71.74 | 71.54 |
| MSR/log(ME)/log(s) | 0.524 | 0.5 | 0.512 |
| EAB/% | 782 | 704 | 696 |
| TAB/MPa | 20 | 19 | 19 |
| Hardness Shore A | 41 | 41 | 42 |
| Rebound resilience at 60°/% | 71 | 71 | 71 |
| Rebound resilience at 23° C./% | 71 | 70 | 71 |
| Tan delta (100° C., 3°)/Hz | 0.106 | 0.099 | 0.097 |
| Dynamic stiffness | 1.152 | 1.135 | 1.125 |

Examples 4 to 7 show that at an EPC level between 80 and 150, preferably 100 to 150 and by using a minimum ENB content of at least 7.5% by weight and by using at least one polymer with a C2 content of 59 to 65% similar good elastic, dynamic and mechanical properties could be generated as of Comparative Example 11 but at molecular weight distributions greater than 3. Therefore, such blends are considered to provide the same elastic, dynamic and mechanical properties but are easier to process.

1. A polymer composition comprising at least one EPDM polymer, wherein the at least one EPDM polymer comprises
(i) from 59% to 70% by weight of units derived from ethylene, and
(ii) from 7.5 to 20% by weight of units derived from one or more non-conjugated dienes, wherein the EPDM polymer comprises at least 6.0% by weight of units derived from the non-conjugated diene 5-ethylidene-2-norbornene (ENB),
(iii) at least 17% by weight of units derived from propylene,
(iv) from 0 to 70 parts per hundred parts of first polymer of extender oil,
(v) optionally, from 0 to 20% by weight of units derived from one or more other comonomers,
wherein the % by weight is based on the total weight of the polymer which is 100%,
and wherein the EPDM polymer has an ENB content per polymer chain (EPC) of from 80 to 150 determined according to equation (I):
$$EPC = ( [ ENB ] \times 10 \times Polymer Mn ) / 120 g / mol \qquad ( I )$$
wherein ‘[ENB]’ is the content of units derived from ENB in the EPDM polymer in % by weight (based on the total weight of the polymer which is 100% by weight) and Polymer Mn is the number average molecular weight of the EPDM polymer in kg/mol as determined by gel permeation chromatography.

2. The polymer composition according to claim 1 wherein the polymer composition comprises at least 90% by weight based on the total weight of the composition of the EPDM polymer and one or more extender oils.

3. The polymer composition according to claim 1 wherein the EPDM polymer has an ENB content per polymer chain of from 100 to 140.

4. The polymer composition according to claim 1 wherein the EPDM polymer has a molecular weight distribution of greater than 3.

5. The polymer composition according to claim 1 wherein the EPDM polymer has a weight-averaged molecular weight (Mw) of at least 500 kg/mol.

6. The polymer composition according to claim 1 wherein the EPDM polymer is obtained by solution polymerization.

7. A polymer blend composition comprising a blend of a first EPDM polymer and a second EPDM polymer wherein the polymer blend has an ENB content per polymer chain of from 80 to 150
and
wherein the first EPDM polymer has from 59% to 65% by weight of units derived from ethylene and at least 17% by weight of units derived from propylene and further comprises units derived from at least one non-conjugated diene, wherein the % by weight is based on the total weight of the first EPDM polymer,
wherein the second EPDM polymer has from 35 to 65% by weight of units derived from ethylene, from at least 17% by weight of units derived from propylene and further comprises units derived from and at least one non-conjugated diene, wherein the % by weight is based on the total weight of the second EPDM polymer,
from 0 to 70 parts per hundred parts of first and second EPDM polymer of extender oil,
optionally, wherein either the first or the second EPDM polymer or both comprise from 0 to 20% by weight, based on the total weight of the respective polymer, of units derived from one or more other comonomers,
and wherein the polymer blend has a total ENB content of from 7.5 to 20% by weight based on the total weight of the polymer blend.

8. The polymer blend composition according to claim 7 wherein the blend is a dry blend.

9. The polymer blend composition according to claim 7 or 8 wherein the weight ratio of the first EPDM polymer to the second EPDM polymer is from 3:1 to 1:3.

10. The polymer blend composition according to claim 7 to 9 wherein the blend has an ENB content per polymer chain of from 100 to 140.

11. The polymer blend composition according to claim 7 having a molecular weight distribution of greater than 3.

12. The polymer blend composition according to claim 7 wherein either the first or the second EPDM polymer has a weight-averaged molecular weight of at least 500 kg.

13. A rubber compound comprising the polymer composition according to claim 1 and further comprising at least one filler and at least one curing agent, wherein, optionally, the rubber compound is a vulcanized rubber compound and comprises the reaction product of subjecting the rubber compound to a curing reaction.

14. Method of making the rubber compound of claim 13 comprising combining the polymer composition with at least one filler and at least one curing agent, and, optionally, subjecting the compound to a curing reaction.

15. Article comprising the rubber compound of claim 13, optionally in a cured form.

16. A rubber compound comprising the polymer blend composition according to claim 7 and further comprising at least one filler and at least one curing agent, wherein, optionally, the rubber compound is a vulcanized rubber compound and comprises the reaction product of subjecting the rubber compound to a curing reaction.

17. Method of making the rubber compound of claim 16 comprising combining the polymer blend with at least one filler and at least one curing agent, and, optionally, subjecting the compound to a curing reaction.

18. Article comprising the rubber compound of claim 16, optionally in a cured form.
